(19) United States
(12) Patent Application Publication
(10) Pub. No.: US 2025/0333570 A1
(43) Pub. Date: Oct. 30, 2025

(54) COMPRESSED, OPEN-PORE, FINE-CELL PUR/PIR RIGID FOAM

(71) Applicant: Covestro Deutschland AG, Leverkusen (DE)

(72) Inventors: Verena Goldbach, Köln (DE); Marina Reithmeier, Köln (DE); Richard Reithmeier, Köln (DE); Hueseyin Goecdue, Köln (DE); Tobias Wollersheim, Leverkusen (DE); Josip Gaca, Leverkusen (DE); Yusuf Koektas, Köln (DE)

(21) Appl. No.: 18/867,129

(22) PCT Filed: May 22, 2023
(86) PCT No.: PCT/EP2023/063584

§ 371 Date: Nov. 19, 2024

(30) Foreign Application Priority Data
May 31, 2022 (EP) 22176274.3

(51) Int. Cl. C08J 9/12; C08J 9/36

(52) U.S. Cl. CPC C08J 9/122; C08J 9/36; C08J 2203/06; C08J 2203/08; C08J 2205/05; C08J 2205/10; C08J 2375/04

(57) ABSTRACT

The present invention relates to a method for producing compressed, open-pore, fine-cell polyurethane rigid foams, to the polyurethane rigid foams so obtained and to their use.

The present invention relates to a process for producing compressed, open-celled, fine-celled rigid polyurethane foams, to the obtained rigid polyurethane foams and to the use thereof.

The rigid polyurethane foams may contain not only urethane groups (PUR) but also isocyanurate groups (PIR). In the present application, unless otherwise stated, the description rigid polyurethane foam or rigid PUR/PIR foam is to be understood as meaning not only rigid foams comprising substantially urethane groups but also rigid foams containing both urethane groups and isocyanurate groups.

Rigid polyurethane foams have long been known. Thermal insulation is a substantial field of application. The use of vacuum insulation panels (VIP) containing rigid polyurethane foams for insulation is becoming increasingly important. Foam quality has a decisive influence on the insulation properties of foams used for vacuum insulation: on the one hand, a very small cell size and very homogeneous cell sizes are advantageous, and on the other hand a high proportion of open cells is advantageous to allow the foam to be readily evacuated.

The production of open-celled rigid polyurethane foams is likewise known in principle. Certain cell- opening substances are generally added to the reaction mixture to bring about an opening of the cells during the foaming process.

WO 2018/162372 A1 discloses a process for producing a fine-celled, open-celled rigid polyurethane foam. This comprises introducing a supercritical CO₂-containing reaction mixture into a mold under counterpressure followed by rapid depressurization thereof. The particular composition of the reaction mixture results in foams of particularly low density, high open-cell content and low cell size being obtained.

It is generally always sought to achieve an ever-improved combination of properties in rigid polyurethane foams, for example to further improve—i.e. reduce—the thermal conductivity of a foam without having to accept significant trade-offs in terms of mechanical properties.

It has been proposed numerous times to compress open-celled rigid polyurethane foams. Thus. DE 102005021994 A1 discloses a process in which a rigid polyurethane foam for VIP is compressed after curing and before evacuation. However, neither the chemical composition, nor the open-cell content, the cell size or the density of the rigid polyurethane foams is disclosed. Since WO 2018/162372 A1 for the first time disclosed a rigid polyurethane foam which exhibits both a low density and a low cell size coupled with a large proportion of open cells, the foam of DE 102005021994 A1 cannot be such a foam. This document especially teaches that compression of a rigid polyurethane foam necessarily entails a deterioration in the mechanical properties.

It is an object of the present invention to further reduce the thermal conductivity of the open-and fine-celled rigid polyurethane foams of low density known from the prior art, in particular without having to accept significant trade-offs in terms of mechanical properties, for instance compressive strengths parallel and/or transverse to the foaming direction.

The object was surprisingly achieved by a process for producing a compressed, open-celled, rigid PUR/PIR foam comprising the steps of
i. producing a reaction mixture R) comprising
   an isocyanate-reactive composition A) comprising
      a polyol component A1) having a functionality f of >2.5 comprising at least one polyether polyol, polyester polyol, polycarbonate polyol, polyether- polycarbonate polyol, polyether ester polyol or mixtures thereof,
      optionally a catalyst component A2),
      optionally an assistant and additive component A3);
   a polyisocyanate component B); and
   a blowing agent component C) comprising CO₂ in the supercritical state,
ii. introducing the reaction mixture R) from step i, into a closed mold, wherein a counterpressure in the closed mold during introduction is 2.0-90 bar,
iii. foaming the reaction mixture R) in the closed mold in a foaming direction to obtain a rigid PUR/PIR foam having a thickness Dₑ in a dimension substantially perpendicular to the foaming direction,
iv. demolding the rigid PUR/PIR foam,
v. compressing the thickness Dₑ of the rigid PUR/PIR foam to a thickness Dₖ to obtain the compressed rigid PUR/PIR foam, wherein Dₖ is 0.05·Dₑ to 0.95·Dₑ and wherein step v, may be performed before or after step iv.

A step i, thus comprises producing a reaction mixture by mixing with one another at least CO₂ in the supercritical state, an isocyanate-reactive composition A) and a polyisocyanate component B). The isocyanate-reactive composition A) comprises here at least one polyol component A1) having a functionality of 2.5 comprising at least one polyether polyol, polyester polyol, polycarbonate polyol, polyether-polycarbonate polyol, polyether ester polyol or mixtures thereof. The composition A) may further comprise a catalyst component A2), an assistant and additive component A3) or both a catalyst component A2) and an assistant and additive component A3). The composition A) may finally also comprise low molecular weight isocyanate-reactive compounds A4) and/or further isocyanate-reactive compounds A5) such as graft polyols, polyamines, polyamino alcohols and polythiols. Conceivable here are all combinations of A1) with A2), A3), A4) and/or A5), i.e. A1) with A2); A1) with A3); A1) with A4); A1) with A5); A1) with A2) and A3); A1) with A2) and A4); A1) with A2) and A5); A1) with A3) and A4); A1) with A3) and A5); A1) with A4) and A5); A1) with A2), A3) and A4); A1) with A2), A3) and A5); A1) with A2), A4) and A5); A1) with A3), A4) and A5).

A step ii, comprises introducing the reaction mixture obtained in step i, into a closed mold, wherein a counterpressure of 2.0 to 90 bar prevails therein.

A step iii, comprises foaming the reaction mixture in the closed mold to obtain a rigid PUR/PIR foam. The foaming is carried out in a certain direction, the so-called foaming direction. If the reaction mixture is disposed on the bottom of a cuboid before foaming for example and if the foam formed during foaming rises vertically upwards, the vertical pointing upwards is the foaming direction. The resulting foam has a thickness Dₑ substantially perpendicular to the foaming direction. In the context of the present application, a direction Y “substantially perpendicular” to the direction X is a direction Y which is at an angle of (90±10)° to the direction X.

A step iv, comprises demolding the rigid PUR/PIR foam.

A step v, comprises compressing the rigid PUR/PIR foam. This compressing may be carried out after the demolding or before the demolding in the closed mold. The thickness Dₑ is compressed here to a thickness Dₖ from 0.05·Dₑ to 0.95·Dₑ.

The solution is surprising because the underlying foams are already very fine-celled, i.e, have very small cell sizes for polyurethane foams of in some cases less than 100 μm. It is firstly unexpected that such fine-celled foams even withstand a compressing according to the invention without destruction of the cell structure. It is also unexpected that the compressing results in a reduction in thermal conductivity in the case of such fine-celled foams since, for a given foam, thermal conductivity generally likewise increases with increasing density. Compression of fine-celled foams would especially have been expected to cause the conductivity of the polymer material to become dominant and the conductivity of the foam to increase. It is finally also surprising that the mechanical properties of the obtained foam, in particular the compressive strength, are retained.

In one embodiment, the proportion of all primary OH functions present in the polyol component A1) based on the total number of terminal OH functions in the polyol component A1) is at least 30%.

In a further embodiment, the thickness Dₑ is compressed to a thickness Dₖ which is 0.20 to 0.95·Dₑ, preferably 0.35 to 0.95·Dₑ, or 0.35 to 0.95·Dₑ, more preferably 0.50 to 0.95·Dₑ or 0.50 to 0.90·Dₑ.

In one embodiment, the number of NCO groups in the polyisocyanate component B) and the number of isocyanate-reactive hydrogen atoms of the isocyanate-reactive composition A) are in a numerical ratio to one another of ≥110:100 to ≤300:100.

In a further embodiment, the reaction mixture R) is substantially free from cell-opening compounds or contains no cell-opening compounds. The expression “substantially free from” is to be understood here as meaning that the reaction mixture R) contains cell-opening compounds at most in an amount corresponding to an unintended contamination, for example less than 0.1% by weight based on the total amount of the isocyanate-reactive composition A.

In another embodiment, step i) is carried out under conditions supercritical for CO₂. In a preferred embodiment, both step i, and step ii, are carried out under conditions supercritical for CO₂.

In a further embodiment, step iii, comprises maintaining the counterpressure for a period 1 of 1-40 s after termination of step ii, and subsequently releasing the counterpressure over a period 2 at a depressurization rate of 1-90 bar/s.

In another embodiment, the polyol component A1) has a hydroxyl number of 280-600 mg KOH/g, measured according to DIN 53240-2:2007.

In one embodiment, the isocyanate-reactive composition A) consists to an extent of at least 65% by weight of the polyol component A1) having a hydroxyl number between 280 to 600 mg KOH/g, measured according to DIN 53240-2:2007, and a functionality of ≥2.8 to ≤6.0. In a further embodiment, the proportion of primary OH functions present in the isocyanate-reactive composition A) based on the total number of all terminal OH functions in the isocyanate-reactive composition A is at least 35%. In a preferred embodiment, the isocyanate-reactive composition A) consists to an extent of at least 65% by weight, based on the total amount of A) excluding A2) and A3), of the polyol component A1) having a hydroxyl number between 280 to 600 mg KOH/g, measured according to DIN 53240-2:2007, and a functionality of ≥2.8 to ≤6.0, and the proportion of primary OH functions present in the isocyanate-reactive composition A) based on the total number of all terminal OH functions in the isocyanate-reactive composition A is at least 35%.

In a further embodiment, the isocyanate-reactive composition A) consists to an extent of at least 60% by weight of polyether polyol.

The isocyanate-reactive composition A) contains at least one polyol component A1) selected from the group consisting of polyether polyols, polyester polyols, polyether ester polyols, polycarbonate polyols and polyether-polycarbonate polyols.

The proportion of primary OH functions based on the total number of terminal OH functions in the polyol component A1) is preferably at least 30%, more preferably at least 35%, especially preferably at least 38%.

The polyol component A1) has the further feature that it has a functionality f of >2.5. preferably ≥2.6 to ≤6.5 and particularly preferably ≥2.8 to ≤6.1. Isocyanate-reactive compositions in which the polyol component A1) has a functionality in these ranges provide an optimal viscosity increase until depressurization of the counterpressure during injection and allow faster demolding of the foams.

The polyol component A1) preferably has a hydroxyl number of 280-600 mg KOH/g, particularly preferably of 300-580 mg KOH/g and especially preferably of 350-540 mg KOH/g. This has a particularly advantageous effect on the mechanical properties of the foams.

In the context of the present application, “a polyether polyol” may also be a mixture of different polyether polyols, this also applying analogously to the other polyols recited here.

The polyether polyols employable according to the invention are the polyether polyols known to those skilled in the art and employable in polyurethane synthesis.

Employable polyether polyols include for example the polytetramethylene glycol polyethers obtainable through polymerization of tetrahydrofuran by cationic ring opening.

Suitable polyether polyols likewise include adducts of styrene oxide, ethylene oxide, propylene oxide, butylene oxide and/or epichlorohydrin to di- or polyfunctional starter molecules. The addition of ethylene oxide and propylene oxide is especially preferred. Suitable starter molecules are for example water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, bisphenols, in particular 4,4′-methylenebisphenol, 4,4′-(1-methylethylidene)bisphenol, 1,4-butanediol, 1.6-hexanediol and low molecular weight hydroxyl- containing esters of such polyols with dicarboxylic acids and oligoethers of such polyols.

It is preferable when, based on its total weight, the isocyanate-reactive composition A) contains at least 50% by weight, preferably at least 60% by weight, especially preferably at least 70% by weight, of polyether polyol. In a preferred embodiment, the component A1) consists of polyether polyol to an extent of 100% by weight. These preferred embodiments feature particularly good hydrolysis stability.

Employable polyether ester polyols are compounds containing ether groups, ester groups, and OH groups. Organic dicarboxylic acids having up to 12 carbon atoms are suitable for producing the polyether ester polyols, preferably aliphatic dicarboxylic acids having ≥4 to ≤6 carbon atoms or aromatic dicarboxylic acids used individually or in admixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. Also employable in addition to organic dicarboxylic acids are derivatives of these acids, for example their anhydrides and also their esters and monoesters with low molecular weight monofunctional alcohols having ≥1 to ≤4 carbon atoms. The use of proportions of the abovementioned biobased starting materials, especially of fatty acids or fatty acid derivatives (oleic acid, soybean oil etc.), is likewise possible and can have advantages, for example in respect of storage stability of the polyol formulation, dimensional stability, fire behavior, and compressive strength of the foams.

Polyether polyols obtained by alkoxylation of starter molecules such as polyhydric alcohols are a further component used for producing polyether ester polyols. The starter molecules are at least difunctional, but may optionally also contain proportions of higher-functionality, especially trifunctional, starter molecules.

Starter molecules are for example diols having number-average molecular weights Mn of preferably ≥18 g/mol to ≤400 g/mol, preferably of ≥62 g/mol to ≤200 g/mol, such as 1,2-ethanediol, 1,3- propanediol, 1,2-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl-1,3-propanediol, 2,2- dimethyl-1,3-propanediol, 3-methyl-1,5-pentanediol, 2-butyl-2-ethyl-1,3-propanediol, 2-butene-1,4- diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomeric mixtures of alkylene glycols, such as diethylene glycol. Starter molecules having functionalities other than OH can also be used alone or in a mixture.

In addition to the diols, compounds having >2 Zerewitinoff-active hydrogens, in particular having number-average functionalities of >2 to ≤8, in particular of ≥3 to ≤6, may also be co-used as starter molecules for producing the polyethers, for example 1,1,1-trimethylolpropane, triethanolamine, glycerol, sorbitan and pentaerythritol and also triol- or tetraol-started polyethylene oxide polyols having average molar masses Mn of preferably ≥62 g/mol to ≤400 g/mol, in particular of ≥92 g/mol to ≤200 g/mol.

Polyether ester polyols may also be produced by the alkoxylation, especially by ethoxylation and/or propoxylation, of reaction products obtained by the reaction of organic dicarboxylic acids and derivatives thereof as well as components having Zerewitinoff-active hydrogens, especially diols and polyols. Derivatives of these acids that may be employed include for example their anhydrides, for example phthalic anhydride.

Suitable polyester polyols are inter alia polycondensates of di- and moreover tri- and tetraols and di- and moreover tri- and tetracarboxylic acids or hydroxycarboxylic acids or lactones. Also employable instead of the free polycarboxylic acids are the corresponding polycarboxylic anhydrides or corresponding polycarboxylic esters of lower alcohols for producing the polyesters.

Examples of suitable diols are ethylene glycol, butylene glycol, diethylene glycol, triethylene glycol, polyalkylene glycols such as polyethylene glycols and also 1,2-propanediol, 1,3-propanediol, 1,3- and 1,4-butanediol, 1,6-hexanediol and isomers, neopentyl glycol or neopentyl glycol hydroxypivalate. Also employable in addition are polyols such as trimethylolpropane, glycerol, erythritol, pentaerythritol, trimethylolbenzene or trishydroxyethyl isocyanurate.

In addition, monohydric alkanols can additionally also be co-used.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3- diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as the acid source.

Additional co-use of monocarboxylic acids such as benzoic acid and alkanecarboxylic acids is also possible.

Hydroxycarboxylic acids that may be co-used as reaction participants in the preparation of a polyester polyol having terminal hydroxyl groups are for example hydroxycaproic acid, hydroxybutyric acid, hydroxydecanoic acid, hydroxystearic acid and the like. Suitable lactones are inter alia caprolactone, butyrolactone, and homologs.

Suitable compounds for producing the polyester polyols also include in particular biobased starting materials and/or derivatives thereof, for example castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower kernel oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified and epoxidized fatty acids and fatty acid esters, for example based on myristoleic acid, palmitoleic acid, oleic acid, vaccenic acid, petroselic acid, gadoleic acid, erucic acid, nervonic acid, linoleic acid, alpha- and gamma-linolenic acid, stearidonic acid, arachidonic acid, timnodonic acid, clupanodonic acid and cervonic acid. Particular preference is given to esters of ricinoleic acid with polyfunctional alcohols, for example glycerol. Preference is also given to the use of mixtures of such biobased acids with other carboxylic acids, for example phthalic acids.

Polycarbonate polyols that may be used are polycarbonates having hydroxyl groups, for example polycarbonate diols. These are obtainable via reaction of carbonic acid derivatives, such as diphenyl carbonate, dimethyl carbonate or phosgene, with polyols, preferably diols, or via copolymerization of alkylene oxides, for example propylene oxide, with CO₂.

Examples of such diols are ethylene glycol, 1,2- and 1,3-propanediol, 1,3- and 1,4-butanediol, 1,6- hexanediol, 1,8-octanediol, neopentyl glycol, 1,4-bishydroxymethylcyclohexane, 2-methylpropane- 1,3-diol, 2,2,4-trimethylpentane-1,3-diol, dipropylene glycol, polypropylene glycols, dibutylene glycol, polybutylene glycols, bisphenol A and lactone-modified diols of the abovementioned type.

Also employable instead of or in addition to pure polycarbonate diols are polyether-polycarbonate diols obtainable for example by copolymerization of alkylene oxides, for example propylene oxide. with CO₂.

Processes for preparing the polyols have been described for example by Ionescu in “Chemistry and Technology of Polyols for Polyurethanes”. Rapra Technology Limited. Shawbury 2005, p. 55 ff. (chapt. 4: Oligo-Polyols for Elastic Polyurethanes), p. 263 et seq. (chapt. 8: Polyester Polyols for Elastic Polyurethanes) and in particular on p. 321 et seq. (chapt. 13: Polyether Polyols for Rigid Polyurethane Foams) and p. 419 et seq. (chapt. 16: Polyester Polyols for Rigid Polyurethane Foams). It is also possible to obtain polyester polyols and polyether polyols by glycolysis of suitable polymer recyclates. Suitable polyether-polycarbonate polyols and the production thereof are described for example in EP 2910585 A, [0024]-[0041]. Examples relating to polycarbonate polyols and production thereof may be found inter alia in EP 1359177 A. Production of suitable polyether ester polyols is described inter alia in WO 2010/043624 A and in EP 1 923 417 A.

Polyether polyols, polyethercarbonate polyols and polyether ester polyols having a high proportion of primary OH functions are obtained when the alkylene oxides used for alkoxylation comprise a high proportion of ethylene oxide. The molar proportion of ethylene oxide structures based on the entirety of the alkylene oxide structures present in the polyols of the component A1 is at least 50 mol %. The use of 100 mol % of ethylene oxide is likewise a preferred embodiment.

The isocyanate-reactive composition A) may further contain low molecular weight isocyanate- reactive compounds A4), in particular di- or trifunctional amines and alcohols, particularly preferably diols and/or triols having molar masses Mn of less than 400 g/mol, preferably of 60 to 300 g/mol, for example triethanolamine, diethylene glycol, ethylene glycol, glycerol, may be used. Provided such low molecular weight isocyanate-reactive compounds are used for producing the rigid polyurethane foams, for example as chain extenders and/or crosslinking agents, and these do not also fall under the definition of polyol component A1), they are advantageously employed in an amount of up to 5% by weight based on the total weight of the composition A).

In addition to the above-described polyols and isocyanate-reactive compounds, the composition A) may contain further isocyanate-reactive compounds A5), for example graft polyols, polyamines, polyamino alcohols and polythiols. It will be appreciated that the described isocyanate-reactive components also comprise compounds having mixed functionalities.

A preferred isocyanate-reactive composition A) comprises the polyol component A1) having a hydroxyl number of 280 to 600 mg KOH/g and a functionality of ≥2.8 to ≤6.0 in an amount of at least 65% by weight, in particular at least 80% by weight and very particularly preferably more than 90% by weight based on the total amount of A) excluding components A2) and A3) and the proportion of primary OH functions in the composition A) is at least 35% (based on all terminal OH functions in composition A).

Production of the rigid PUR/PIR foam employs supercritical CO₂ as blowing agent component C). The blowing agent component C) is employed in an amount sufficient to achieve a dimensionally stable foam matrix and the desired apparent density. This is generally 0.5-30 parts by weight of blowing agent based on 100 parts by weight of the composition A) excluding A2) and A3).

The CO₂ as physical blowing agent is employed in a supercritical or near-critical state. Conditions are near-critical in the context of the present invention when the following condition is satisfied: (Tc−T)/T≤0.4 and/or (pc−p)/p≤0.4. Here, T is the temperature prevailing in the process, Tc is the critical temperature of the blowing agent or blowing agent mixture, p is the pressure prevailing in the process and pc is the critical pressure for the blowing agent or blowing agent mixture. Conditions are preferably near-critical when: (Tc−T)/T≤0.3 and/or (pc−p)/p≤0.3 and particularly preferably (Tc−T)/T≤0.2 and/or (pc−p)/p≤0.2.

Particularly suitable conditions for performing the process according to the invention when using CO₂ are pressures and temperatures above the critical point of CO₂, i.e. ≥73.7 bar and ≥30.9° C., preferably between 74 bar and 350 bar and between 31° C. and 100° C., particularly preferably between 75 bar and 200 bar and between 32° C. and 60° C.

Physical blowing agents may be employed as additional blowing agents in addition to supercritical CO₂. In the context of the present invention, “physical blowing agents” are to be understood as meaning compounds which on account of their physical properties are readily volatile and do not react with the polyisocyanate component B).

The additional physical blowing agents may be selected from the group of hydrocarbons (for example n-pentane, isopentane, cyclopentane, butane, isobutane, propane), ethers (for example methylal), halogenated ethers, perfluorinated and partially fluorinated hydrocarbons having 1 to 8 carbon atoms, for example perfluorohexane, HFC 245fa (1,1,1,3,3-pentafluoropropane), HFC 365mfc (1,1,1,3,3- pentafluorobutane), HFC 134a or mixtures thereof may be used, and also (hydro)fluorinated olefins, for example HFO 1233zd (E) (trans-1-chloro-3,3,3-trifluoro-1-propene) or HFO 1336mzz (Z) (cis- 1,1,1,4,4,4-hexafluoro-2-butene) or additives such as FA 188 from 3M (1,1,1,2,3,4,5,5,5-nonafluoro- 4-(trifluoromethyl)pent-2-ene), and also mixtures thereof with one another.

When further blowing agents are added, the blowing agent component C) in one embodiment preferably contains more than 60% by weight of supercritical CO₂, particularly preferably more than 75% by weight.

It is also possible to use chemical blowing agents (also “co-blowing agents”) in addition to, or instead of, the physical blowing agents. These are particularly preferably water and/or formic acid. It is preferable when the co-blowing agents are employed in an amount of 0% to 6% by weight, particularly preferably of 0.5% to 4% by weight, based on the total amount of compounds having isocyanate-reactive hydrogen atoms in the foam-forming reaction mixture R).

The proportion of the blowing agent C), in each case based on the total amount of the components A) and C), is preferably ≥1% by weight to ≤30% by weight, more preferably ≥4% by weight to ≤20% by weight, particularly preferably ≥6% by weight to ≤16% by weight; the proportion of the blowing agent in the reaction mixture R) is 0.5% by weight to 15% by weight, preferably 2% by weight to 10% by weight, particularly preferably ≥3% by weight to ≤8% by weight, in each case based on the total amount of R).

In a further embodiment, the isocyanate-reactive composition A) comprises a catalyst component A2), preferably a catalyst component A2) in an amount of ≥0.01 to <2.0% by weight, based on the total weight of the isocyanate-reactive composition A).

Typically employed as catalyst component A2) are compounds which accelerate the reaction of the hydroxyl group-containing or isocyanate-reactive group-containing compounds of composition A) with the isocyanate groups of component B.

The catalyst component A2) may contain A2a) at least one catalytically active amine compound having functional groups which comprise Zerewitinoff-active hydrogens and can therefore react with isocyanate (so-called “incorporable catalysts”). Examples of employable incorporable catalysts are bis(dimethylaminopropyl)urea, bis(N,N-dimethylaminoethoxyethyl)carbamate, dimethylamino- propylurea, N,N,N-trimethyl-N-hydroxyethylbis (aminopropyl ether), N,N,N-trimethyl-N- hydroxyethylbis (aminoethyl ether), diethylethanolamine, bis(N,N-dimethyl-3-aminopropyl)amine, dimethylaminopropylamine, 3-dimethylaminopropyl-N,N-dimethylpropane-1,3-diamine, dimethyl- 2-(2-aminoethoxyethanol) and (1,3-bis(dimethylamino)propan-2-ol), N,N-bis(3- dimethylaminopropyl)-N-isopropanolamine, bis(dimethylaminopropyl)-2-hydroxyethylamine, N,N,N-trimethyl-N-(3-aminopropyl)-bis(aminoethyl ether), 3-dimethylaminoisopropyldiiso- propanolamine or mixtures thereof.

Also employable are one or more further compounds A2b), especially the catalytically active compounds known for PUR/PIR chemistry, including not only further amine compounds but also salts such as for example tin(II) acetate, tin(II) octoate, tin(II) ethylhexoate, tin(II) laurate, dibutyltin diacetate, dibutyltin dilaurate, dibutyltin maleate, dioctyltin diacetate, tris(N,N- dimethylaminopropyl)-s-hexahydrotriazine, tetramethylammonium hydroxide, sodium acetate, sodium octoate, potassium acetate, potassium octoate, sodium hydroxide.

The catalyst component A2) is generally employed in an amount of 0.001% to 5% by weight, in particular of 0.05% to 2.5% by weight, based on the weight of the composition A). It is particularly preferable when the catalyst component A2) contains both incorporable catalysts A2a) and non-incorporable catalysts A2b). It is especially preferable when incorporable amine compounds and catalytically active salts are employed in combination.

The catalysts A2a) and A2b) are preferably employed in a molar ratio A2a)/A2b) of 0.1 to 16.3, particularly preferably of 0.3 to 10 and very particularly preferably of 0.8 to 6.0. It is preferable when the catalyst component A2) contains as the catalytically active compound A2a) an amine compound incorporable into the polyurethane and also the catalytically active compound A2b) which is a catalytically active salt not incorporable into the polyurethane and the molar ratio of A2a)/A2b) is 0.1 to 16.3, particularly preferably from 0.3 to 10 and very particularly preferably from 0.8 to 6.0. In a particularly preferred embodiment, 3-(dimethylamino)propylurea and potassium acetate are employed in a molar ratio A2a)/A2b) of 0.1 to 6.0, particularly preferably of 0.3 to 10 and very particularly preferably of 0.8 to 6.0. The preferred catalyst ratios/catalysts particularly advantageously bring about a defined viscosity increase.

In one embodiment, the isocyanate-reactive composition A) comprises an assistant and additive component A3) comprising a stabilizer, preferably a stabilizer in an amount of ≥0.05% to <5% by weight based on the total weight of the isocyanate-reactive composition A).

In a further embodiment, the reaction mixture R) is substantially free from cell-opening compounds or contains no cell-opening compounds. The expression “substantially free from” is to be understood here as meaning that the reaction mixture R) contains cell-opening compounds at most in an amount corresponding to an unintended contamination, for example less than 0.1% by weight based on the total amount of the isocyanate-reactive composition A.

The reaction mixture R) may contain assistant and additive substances A3). The assistant and additive substances may contain cell-opening compounds but are preferably free from or comprise substantially no cell-opening compounds. Cell-opening compounds are described for example in Kunststoff-Handbuch, volume 7, Polyurethane, Carl Hanser Verlag, Munich/Vienna, 3rd edition, 1993, pages 104-127. These are, for example, silicones, such as polyether-polydimethylsiloxane copolymers, or organic polymers, for example those based on polybutadiene (for example Ortegol 500 and 501 from Evonik Industries), surfactants, for example the sodium salt of ethoxylated and sulfated isotridecyl alcohol obtainable under the trade name Sermul EA266 (Elementis Specialties. the Netherlands), and also mixtures of different components, for example mixtures of amine- stabilized, macromolecular, unsaturated hydrocarbons and phthalate esters.

Further assistant and additive substances A3) that may be employed in the process according to the invention are the customary assistant and additive substances known from the prior art and to the person skilled in the art. These include for example surface-active substances, stabilizers, in particular foam stabilizers, cell regulators, fillers, dyes, pigments, flame retardants, antistats, antihydrolysis agents and/or fungistatic and bacteriostatic substances.

Polyether-polydimethylsiloxane copolymers are often used as foam stabilizers, preferably a polyethylene oxide-polyether having oligodimethylsiloxane end groups, wherein the number of dimethyl siloxane units is preferably ≤5.

Employable stabilizers also include saturated and unsaturated hydrocarbons such as paraffins, polybutadienes, fatty alcohols and esters, for example esters of carboxylic acids. It is preferable to employ stabilizers, in particular foam stabilizers, that do not have a cell-opening effect.

The composition A) preferably contains altogether not more than 3% by weight of silicones and polybutadienes.

Also employable as stabilizers are surfactants, for example alkoxylated alkanols such as ethers of linear or branched alkanols having ≥6 to ≤30 carbon atoms with polyalkylene glycols having ≥5 to ≤100 alkylene oxide units, alkoxylated alkylphenols, alkoxylated fatty acids, carboxylic esters of an alkoxylated sorbitan (especially Polysorbate 80), fatty acid esters, polyalkyleneamines, alkyl sulfates, phosphatidylinositols, fluorinated surfactants, surfactants comprising polysiloxane groups and/or bis(2-ethyl-1-hexyl) sulfosuccinate. Fluorinated surfactants may be perfluorinated or partially fluorinated. Examples thereof are partially fluorinated ethoxylated alkanols or carboxylic acids.

The composition A) preferably contains a total of not more than 5% by weight of surfactants, especially preferably not more than 3% by weight, more preferably less than 2% by weight and especially preferably not more than 1.6% by weight of surfactants based on the total weight of the composition A).

The reaction mixture R) comprises a polyisocyanate component B), i.e, an isocyanate having an NCO functionality of ≥2. Examples of such suitable polyisocyanates include 1,4-butylene diisocyanate, 1,5-pentane diisocyanate, 1,6-hexamethylene diisocyanate (HDI), isophorone diisocyanate (IPDI), 2,2,4- and/or diisocyanate, 2,4,4-trimethylhexamethylene the isomeric bis(4,4′- isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5- naphthylene diisocyanate, 2,2′- and/or 2,4′- and/or 4,4′-diphenylmethane diisocyanate (MDI) and/or higher homologs, 1,3- and/or 1,4-bis(2-isocyanatoprop-2-yl)benzene (TMXDI), 1,3- bis(isocyanatomethyl)benzene (XDI) and also alkyl 2,6-diisocyanatohexanoates (lysine diisocyanates) having C1 to C6-alkyl groups.

Materials used as isocyanate component B) are preferably mixtures of the isomers of diphenylmethane diisocyanate (“monomeric MDI”), abbreviated to “mMDI”) and its oligomers (“oligomeric MDI”). Mixtures of monomeric MDI and oligomeric MDI are generally referred to by the term “polymeric MDI” (pMDI). The oligomers of MDI are polyphenyl polymethylene polyisocyanates having a relatively large number of rings, i.e, mixtures of the homologs of diphenylmethane diisocyanate which have a relatively large number of rings and which have an NCO functionality f>2 and have the following structural formula: C15H10N2O2 [C8H5NO]n, wherein n=integer>0), preferably n=1, 2, 3 and 4. Homologs C15H10N2O2 [C8H5NO]m, m=integer>4) having a relatively large number of rings may likewise be present in the mixture of organic polyisocyanates a). Likewise preferred as the isocyanate component B) are mixtures of mMDI and/or pMDI comprising at most up to 20% by weight, more preferably at most 10% by weight, of further aliphatic, cycloaliphatic and especially aromatic polyisocyanates known for the production of polyurethanes, very particularly TDI.

In addition to the abovementioned polyisocyanates, it is also possible to include proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than two NCO groups per molecule, for example 4- isocyanatomethyl-1,8-octane diisocyanate (nonane triisocyanate) or triphenylmethane 4,4′,4″-triisocyanate.

Suitable NCO prepolymers can also be used as organic isocyanate component B), instead of or in addition to the abovementioned polyisocyanates. The prepolymers are producible by reaction of one or more polyisocyanates with one or more polyols corresponding to the polyols described under the components A1) and A2).

It is possible for the isocyanate to be a prepolymer obtainable by reacting an isocyanate having an NCO functionality of ≥2 and polyols having a molecular weight of ≥62 g/mol to ≤8000 g/mol and OH functionalities of ≥1.5 to ≤6.

The NCO content is preferably from ≥29.0% by weight to ≤32.0% by weight and preferably has a viscosity at 25° C. of ≥80 mPas to ≤2000 mPas, particularly preferably of ≥100 mPas to ≤800 mPas (dynamic viscosity determined according to DIN 53019 at 25° C.).

The number of NCO groups in the polyisocyanate component B) and the number of isocyanate- reactive groups of the composition A) may be in a numerical ratio to one another that is by way of example ≥50:100 to ≤300:100. The rigid polyurethane foams are generally produced by reacting the components A) and B) in amounts such that the isocyanate index in the formulation is 80-150, preferably 90-130, particularly preferably 95-125. In this range, urethane groups are preferably formed. In another preferred embodiment, the isocyanate index is 150-300. In this range, the foams comprise a high proportion of isocyanurate functions which bring about for example an inherent flame retardancy of the foams.

The process according to the invention consists at least of steps i, to v.

In step i, of the process according to the invention, the reaction mixture R) is produced from the components A), B) and C).

To this end, the composition A) may for example be initially charged in a vessel, subsequently mixed with the blowing agent component C) and admixed with the polyisocyanate B). The mixing of the components may also be carried out in a mixing head.

The mixing, in particular with the components C) and B), may be carried out under pressure. In a preferred embodiment, the components A) and C) are mixed with the component B) in a high- pressure mixing head.

The blowing agent component C) is CO₂ in the supercritical state and the reaction of the components is preferably carried out under conditions supercritical for CO₂. In this case, suitable pressures in the mixing head and/or in the discharge conduit(s) for producing the polyurethane foam are for example in the range from ≥73.7 bar to ≤350 bar and preferably in the range from ≥75 bar to ≤200 bar. Suitable temperatures are for example ≥30.9° C. to ≤100° C. and preferably ≥32° C. to ≤60° C. At such pressures, supercritical conditions for the employed blowing agent may be maintained.

In a further embodiment, the residence time of the mixture in the mixing head under supercritical conditions for the blowing agent is >0 seconds to ≤20 seconds, preferably from ≥0.1 seconds to ≤10 seconds and particularly preferably from ≥0.5 seconds to ≤5 seconds. This has the result that the mixture can polymerize under supercritical conditions. The residence time may be determined by the volume of the reaction chamber (=mixing chamber and/or conduits) in which supercritical conditions prevail divided by the volume of the mixture conveyed in a particular unit time.

In step ii. of the process according to the invention, the reaction mixture R) according to the invention composed of the components A), B) and C) is introduced into a closed mold, wherein a counterpressure in the mold during introduction is 2.0-90 bar, preferably 2.0-80 bar, especially preferably 5.0-40 bar.

Possible embodiments in this regard are as follows: the counterpressure is achieved by pressurizing the mold with gas (compressed air or nitrogen) either directly and/or via a floating seal dividing the pressurized space into a gas space and a reaction space and is established, held and finally released via a proportional valve.

In step iii. of the process, the reaction mixture is foamed.

A preferred embodiment of step iii) is as follows: after termination of step ii., the counterpressure in the mold is kept constant for a period 1 which is preferably 1-40 seconds, particularly preferably 5- 20 seconds and very particularly preferably 8-17 seconds, wherein the viscosity of the reaction mixture initially increases without foaming of the reaction mixture. It has been found that holding the pressure for the preferred period results in particularly advantageous viscosity ranges of the mixture for this reaction phase. After termination of period 1, the mold is depressurized. The releasing of the pressure from the mold is carried out over a period 2 at a depressurization rate of 1- 90 bar/s, preferably 1-80 bar/s, particularly preferably 2-70 bar/s. The releasing may be effected in particular via a proportional valve. The reaction mixture is foamed over period 2. Excessively fast releasing has a negative effect on cell stability and excessively slow releasing has a negative effect on the foaming reaction.

In step iv. of the process, the rigid PUR/PIR foam is demolded.

In step v. of the process, the rigid PUR/PIR foam is compressed. The compressing may be performed before or after step iv. This comprises reducing the thickness of the rigid PUR/PIR foam.

This may be achieved by volume reduction of the reaction mold for example by inserting plates and re-closing the mold comprising rigid foam. The volume of the reaction mold may be reduced by 5- 95%, preferably by 40-70%. A reduction of Dₑ to Dₖ by 40% corresponds to a reduction to (100- 40) %=60% of Dₑ, i.e, a compressing of a rigid foam of thickness Dₑ=100 mm by 40% corresponds to a compressing to a compressed rigid foam of thickness Dₖ=(100−0.4*100) mm=60 mm.

The compressing in a volume-reduced mold may be performed after a certain period after foaming the reaction mixture. This period may be 10 s-30 min, preferably 1-10 min. It may also be compressed before or after curing of the foam. The duration of the compressing, i.e. of the maintaining of the volume reduction with a closed mold, is 1-30 min, preferably 2-15 min. The time of the compressing and the duration influence the resulting thickness Dₖ of the compressed foam, which is measured 24 h after termination of the compressing.

The rigid foam may alternatively be compressed in a hydraulic press after step iv.

The present invention also provides an open-celled rigid PUR/PIR foam which is obtainable or obtained by the process according to the invention. The foam according to the invention has good mechanical properties, in particular good dimensional stability at elevated temperature and preferably also good compressive strength.

It is preferable when this open-celled rigid PUR/PIR foam has an apparent density of 30-90 kg/m³, preferably 30-120 kg/m³, according to ISO 845:2006, an open-cell content of >90%, preferably ≥94%, according to ISO 4590:2002 and an average (arithmetically averaged) cell diameter of 70-130 um according to optical microscopy evaluation. The value of the average cell diameter relates to the foam not yet compressed in step v.

The PUR/PIR foams according to the invention make it possible in preferable fashion to produce foamed moldings and composite systems containing these moldings. The composite systems are often delimited both on the top surface and on the bottom surface by decorative layers. Suitable decorative layers include inter alia metals, plastics, wood and paper. Suitable fields of application of such discontinuously produced PUR/PIR composite systems include in particular industrial insulation of appliances such as refrigerators, chest freezers, fridge-freezers and boilers, cool containers and coolboxes and also of pipes.

The use of PUR/PIR foams in these fields is known per se to those skilled in the art and has already been described on many occasions. The PUR/PIR foams according to the invention are exceptionally suitable for these purposes since they feature a high dimensional stability and advantageously also a high compressive strength and low coefficients of thermal conductivity, which can be enhanced yet further by application of a vacuum.

Finally, the invention also provides a refrigerator, freezer or a combined fridge-freezer containing a rigid PUR/PIR foam obtainable by the process according to the invention.

Terms used in the present application have the following meaning:

The index (also known as the isocyanate index) is to be understood as meaning the quotient of the actually employed amount of substance [mol] of isocyanate groups and the actually employed amount of substance [mol] of isocyanate-reactive hydrogen atoms, multiplied by 100:

Index=(isocyanate groups [mol]/isocyanate-reactive hydrogen atoms [mol])·100

In the context of the present application. “functionality” or “f” of a compound is to be understood as meaning theoretical functionality: thus, for an exclusively glycerol-started polyol, the functionality f=3, and for an exclusively ethylenediamine-started polyol, f=4. In the context of the present application, the “functionality” or “f” of a component mixture is to be understood as meaning the respective number-average functionality of the mixture to which the indication refers. Thus, for example the functionality of the polyol component A1) is to be understood as meaning the number- average functionality of the mixture of the polyols present in component A1 based on all isocyanate- reactive hydrogen atoms present.

In the context of the present application, “molar weight” or “molar mass” or “Mn” is in each case to be understood as meaning the number-weighted average molar mass.

In the case of a single added polyol, the OH number (also known as: hydroxyl number) specifies the OH number of said polyol. Reported OH numbers for mixtures relate to the number-average OH number of the mixture calculated from the OH numbers of the individual components in their respective molar proportions. The OH value indicates the amount of potassium hydroxide in milligrams that is equivalent to the amount of acetic acid bound by one gram of substance on undergoing acetylation. In the context of the present invention, said number is determined according to the standard DIN 53240-2, as at November 2007.

The invention will now be more particularly elucidated with reference to the following examples and comparative examples, without its scope being limited by the examples.

### EXAMPLES

Employed standards/analytical instruments:

Determination of apparent density: Foams composed of rubber and plastics—determination of apparent density (ISO 845:2006); German version DIN EN ISO 845:2009

Determination of open-cell content: Determination of volume fraction of open and closed cells (ISO 4590:2002); German version DIN EN ISO 4590:2003

Determination of compressive strength: Rigid foams—determination of pressure properties (ISO 844:2014); German version DIN EN ISO 844:2014

Determination of OH number: Determination of hydroxyl number—part 2: Method with catalyst according to DIN 53240-2, November 2007 version

Determination of cell size: Optical microscopy evaluation using a VHX 5000 optical microscope; the test specimen to be analyzed is examined at three different points in each case over a circular region having a diameter of 5 mm. Observation is transverse to the foaming direction. The resolution is chosen such that the selected region captures more than 100 cells. All cells are subsequently evaluated with the freely available software ImageJ and the obtained ECD (equivalent circle diameter) values used to calculate the arithmetically averaged cell diameter.

The specified proportion of primary OH functions in [%] in table 1 relates to the proportion of primary OH functions based on the total number of OH functions in the mixture of the polyols present in the formulation.

### Examples 1-3 and comp, ex. 1-2

Polyurethane foams blown with supercritical CO₂ were produced according to the formulations recited in the following table 1. Unless otherwise stated, the specified amounts are to be understood as weight fractions. The following substances were used:
Polyol 1: Trimethylol-initiated polyether polyol with propylene oxide as the alkylene oxide having a hydroxyl number of 880 mg KOH/g, a functionality of 3 and a viscosity at 25° C. of 6100 mPa·s
Polyol 2: Trimethylol-initiated polyether polyol with ethylene oxide as the alkylene oxide having a hydroxyl number of 550 mg KOH/g, a functionality of 3 and a viscosity at 25° C. of 505 mPa·s
Polyol 3: 1,2-Propanediol-initiated polyether polyol with propylene oxide as the alkylene oxide having a hydroxyl number of 56 mg KOH/g, a functionality of 2 and a viscosity at 25° C. of 310 mPa·s
Polyol 4: 1,2-Propanediol-initiated polyether polyol with propylene oxide as the alkylene oxide having a hydroxyl number of 112 mg KOH/g, a functionality of 2 and a viscosity at 25° C. of 140 mPa·s
Polyol 5: Trimethylolpropane-initiated polyether polyol with propylene oxide as the alkylene oxide having a hydroxyl number of 235 mg KOH/g, a functionality of 3 and a viscosity at 25° C. of 350 mPa·s
Polyol 6: Hydroxy-functional fatty acid esters having a hydroxyl number of 160 mg KOH/g and a functionality of 3.
Tegostab B 8443: Polyether-polydimethylsiloxane copolymer foam stabilizer (Evonik).
Desmorapid PU 1792: Catalyst, potassium acetate in diethylene glycol (Covestro)
Amine ZZ: Catalyst. N′-(3-(dimethylamino)propyl)-N,N-dimethylpropane-1,3-diamine, AirProducts
Isocyanate: Mixture of MDI and PMDI having a functionality of about 2.8, an NCO content of about 31.5% by weight and a viscosity at 25° C. of about 200 mPa·s (Desmodur 44V20L, Covestro)

Production of polyurethane molded foams on a high-pressure apparatus:

To produce molded polyurethane foams on a high-pressure apparatus, a polyol formulation was produced from the isocyanate-reactive compounds, stabilizers, catalysts shown in the following table 1. Said formulation was employed as the polyol component in a standard high-pressure mixing apparatus and mixed with CO₂ at a pressure of 160 bar and a temperature of 50° C. The blowing agent was under supercritical conditions (supercritical CO₂, also known as “scCO₂”). This mixture was mixed with a polyisocyanate conveyed at a pressure of 160 bar and a temperature of 35° C. in a high- pressure mixing head. The shot quantity was 180 g/s, corresponding to a volume flow of 95 ml/s (density of the mixture 1.2 g/ml). The resulting reaction mixture was metered into a closed mold pre- pressurized to a counterpressure of 11 bar at a mold temperature of 55° C. After termination of the injection, the pre-pressurized counterpressure was held for a further 8 s and only then rapidly depressurized to ambient pressure within <2 seconds.

In the process according to the invention, the mold was opened after a predetermined time (see table 1) and to effect the compressing, a plate of a desired thickness (ex. 1. ex. 2: 38% of the foam thickness) was inserted into the mold and the mold was closed again. The mold was subsequently compressed for a predetermined time (ex. 1-2:5 min, ex. 3: 10 min) in the volume-reduced mold and then demolded. In the noninventive process (comp, ex. 1), the mold was merely opened after a predetermined time and the obtained foam was demolded. The foam of ex. 1-3 before compressing was identical to that of comp, ex. 1. Comp, ex. 2 employed a smaller amount of scCO₂, and therefore the resulting foam without compressing had a higher apparent density than ex. 1 and a comparable apparent density to ex. 2.

Example 3 demonstrates that even completely cured foams can be improved in their thermal conductivity by compressing, i.e, thermal conductivity is reduced by the compressing.

Examples 1-3 show that the compressing produces a higher apparent density while simultaneously reducing the arithmetically determined cell sizes. This forms very fine-celled foams having an oval cell shape which surprisingly have low thermal conductivities under vacuum. The compressed foams have the feature that their mechanical properties do not worsen compared to uncompressed foams (comp, ex. 1).

Uncompressed foams, for example a starting foam in comparative example 1, have a higher thermal conductivity despite a lower apparent density. The comparison of foams having apparent densities analogous to the compressed foams (comp, ex. 2 vs. ex. 1-3) shows clearly that, without compressing, very fine-celled foams cannot be produced and thermal conductivity is markedly elevated.

TABLE 1

| | Comp. | | | Comp. | |
|---|---|---|---|---|---|
| | example | Example | Example | example | Example |
| | 1 | 1 | 2 | 2 | 3 |
| Polyol 1 | 13.0 | 13.0 | 13.0 | 13.0 | 13.0 |
| Polyol 2 | 32.50 | 32.50 | 32.50 | 32.50 | 32.50 |
| Polyol 3 | 10.80 | 10.80 | 10.80 | 10.80 | 10.80 |
| Polyol 4 | 7.60 | 7.60 | 7.60 | 7.60 | 7.60 |
| Polyol 5 | 21.60 | 21.60 | 21.60 | 21.60 | 21.60 |
| Castor oil | 10 | 10 | 10 | 10 | 10 |
| Tegostab B 8443 | 2 | 2 | 2 | 2 | 2 |
| Desmorapid PU 1792 | 2.25 | 2.25 | 2.25 | 2.25 | 2.25 |
| Amine ZZ | 0.9 | 0.9 | 0.9 | 0.9 | 0.9 |
| Isocyanate 1 | 94 | 94 | 94 | 94 | 94 |
| scCO₂ | 6.0 | 6.0 | 6.0 | 3.1 | 6.0 |
| Average | 2.9 | 2.9 | 2.9 | 2.9 | 2.9 |
| functionality f | | | | | |
| Primary OH functions [%] | 44 | 44 | 44 | 44 | 44 |
| Time between depressurization | 5 | 5 | 1 | 5 | >2800 |
| and commencement of | | | | | |
| compressing [min] | | | | | |
| Degree of compression of foam | 0 | 25 | 37 | 0 | 20 |
| (1-Dk/De) [%] | | | | | |
| Mechanics | | | | | |
| Apparent density [kg/m³] | 36 | 50 | 78 | 73 | 41 |
| Compressive strength | 0.18 | 0.21 | 0.35 | 0.41 | 0.18 |
| (parallel) (MPa) | | | | | |
| Compressive strength | 0.15 | 0.18 | 0.27 | 0.37 | 0.16 |
| (transverse) (MPa) | | | | | |
| Open-cell content [%] | 96 | 96 | 95 | 95 | 96 |
| Cell size transverse | 86 | 65 | 60 | 90 | 71 |
| (arithmetic average) [μm] | | | | | |
| Appearance of cells | round | oval | oval | round | oval |
| Thermal conductivity under | 10.0 | 8.7 | 6.9 | 13.2 | 9.4 |
| vacuum, (mW · m⁻¹ · K⁻¹) | | | | | |

1. A process for producing a compressed, open-celled, rigid PUR/PIR foam, comprising:
i. producing a reaction mixture R) comprising:
(1) an isocyanate-reactive composition A), comprising:
a polyol component A1) having a functionality f of >2.5 comprising at least one polyether polyol, polyester polyol, polycarbonate polyol, polyether- polycarbonate polyol, polyether ester polyol or a mixture thereof,
optionally a catalyst component A2),
optionally an assistant and additive component A3);
(2) a polyisocyanate component B); and
(3) a blowing agent component C) comprising CO₂ in the supercritical state,
ii. introducing the reaction mixture R) from step i, into a closed mold, wherein a counterpressure in the closed mold during introduction is 2.0-90 bar,
iii. foaming the reaction mixture R) in the closed mold in a foaming direction to obtain a rigid PUR/PIR foam having a thickness Dₑ in a dimension substantially perpendicular to the foaming direction,
iv. demolding the rigid PUR/PIR foam, and
v. compressing the thickness Dₑ of the rigid PUR/PIR foam to a thickness Dₖ to obtain the compressed rigid PUR/PIR foam, wherein Dₖ is 0.05·Dₑ to 0.95·Dₑ and wherein step v. may be performed before or after step iv.

2. The process as claimed in claim 1, wherein the proportion of all primary OH functions present in the polyol component A1) based on the total number of terminal OH functions in the polyol component A1) is at least 30%.

3. The process as claimed in claim 1, wherein the reaction mixture R) is substantially free from cell-opening compounds or contains no cell- opening compounds.

4. The process as claimed in claim 1, wherein step i. and optionally ii. are carried out under conditions supercritical for the CO₂.

5. The process as claimed in claim 1, wherein step iii. comprises maintaining the counterpressure for a period 1 of 1 to 40 seconds after termination of step ii. and subsequently releasing the counterpressure over a period 2 at a depressurization rate of 1-90 bar/second.

6. The process as claimed in claim 1, wherein the polyol component A1) has a hydroxyl number of 280-600 mg KOH/g measured according to DIN 53240-2:2007.

7. The process as claimed in claim 1, wherein the isocyanate-reactive composition A) consists to an extent of at least 65% by weight of the polyol component A1) having a hydroxyl number between 280 to 600 mg KOH/g measured according to DIN 53240-2:2007 and a functionality of ≥2.8 to ≤6.0 and the proportion of primary OH functions present in the isocyanate-reactive composition A) based on the total number of all terminal OH functions in the isocyanate-reactive composition A is at least 35%.

8. The process as claimed in claim 1, wherein the rigid PUR/PIR foam has compressive strengths determined according to DIN EN ISO 844:2014, parallel and transverse to a direction in which it is foamed, which are not both more than 40% lower than compressive strengths determined according to DIN EN ISO 844:2014, parallel and transverse to a direction in which it is foamed, of a rigid PUR/PIR foam of identical apparent density which has been produced by the same process but has not been compressed.

9. The process as claimed in claim 1, wherein the content of blowing agent component C) is 0.5% by weight to 15% by weight based on the total weight of R).

10. The process as claimed in claim 1, wherein the isocyanate-reactive composition A) comprises a catalyst component A2) in an amount of ≥0.01% to <2.0% by weight, based on the total weight of the isocyanate-reactive composition A).

11. The process as claimed in claim 1, wherein the isocyanate-reactive composition A) comprises a stabilizer.

12. A compressed, open-celled, rigid PUR/PIR foam obtained by the process as claimed in claim 1.

13. The compressed, open-celled, rigid PUR/PIR foam as claimed in claim 12 having an apparent density of 30-120 kg/m³ according to ISO 845:2006, an open-cell content of >90% according to ISO 4590:2002, and having an average cell diameter of 40-130 μm according to optical microscopy evaluation.

14. A vacuum insulation panel containing a rigid PUR/PIR foam as claimed in claim 13.

15. A refrigerator, freezer or combined fridge-freezer containing a compressed, open-celled, rigid PUR/PIR foam as claimed in claim 12.

16. A refrigerator, freezer or combined fridge-freezer containing the vacuum insulation panel as claimed in claim 14.
